(19) United States
(12) Patent Application Publication
(10) Pub. No.: US 2015/0195140 A1
(43) Pub. Date: Jul. 9, 2015

(54) APPARATUS AND METHOD FOR SHARING DATA BY USING TOPOLOGY

(71) Applicant: INTELLECTUAL DISCOVERY CO., LTD., Seoul (KR)

(72) Inventor: Jin Suk Kim, Seoul (KR)

(73) Assignee: INTELLECTUAL DISCOVERY CO., LTD., Seoul (KR)

(21) Appl. No.: 14/411,876

(22) PCT Filed: Jul. 1, 2013
(86) PCT No.: PCT/KR2013/005816

§ 371 Date: Dec. 29, 2014

(30) Foreign Application Priority Data
Jun. 29, 2012 (KR) 10-2012-0070714

(51) Int. Cl. H04L 12/24; H04W 84/00; H04L 29/06

(52) U.S. Cl. CPC H04L 41/12; H04L 65/403; H04W 84/00

(57) ABSTRACT

The present invention relates to an apparatus and a method for sharing data by creating a topology, and the method for sharing data by a host terminal comprises the steps of: creating a topology for indicating a configuration of a wireless network between the host terminal and a plurality of adjacent terminals located within a standard distance from the host terminal; transmitting the topology to the plurality of adjacent terminals; receiving a participation request message for requesting participation in the wireless network according to the topology from at least one of the plurality of adjacent terminals; and sharing data, on the basis of the topology, with a least one of the adjacent terminals which transmitted the participation request message.

### CROSS REFERENCE TO RELATED APPLICATIONS

This application is a National Stage of International Application No. PCT/KR2013/005816 filed Jul. 1, 2013, claiming priority based on Korean Patent Application No. 10-2012-0070714 filed Jun. 29, 2012, the contents of all of which are incorporated herein by reference in their entirety for all purposes.

### TECHNICAL FIELD

The present invention relates to an apparatus and method for creating a topology and sharing data, and more particularly, to technical spirit that enables all of terminals to recognize the entire topology state by setting a topology in which a connection structure with adjacent terminals is applied by a host terminal and by sharing locations or an arrangement state between terminals participating in a new connection structure, between the terminals.

### BACKGROUND ART

Recently, the expansion of a smart device has brought a great change to our daily life. In particular, interest and research on a smart work environment that allows a user to keep working without restrictions on a time and an occasion using a smart device are on increase. However, domestic research on smart work still stays in an initial stage and security research on a device accessing a smart work environment is also insufficient.

With the expansion of a communication terminal market, types or functions of applications available at a communication terminal are increasing.

Here, a technology for communication between adjacent devices using a variety of methods to transmit and receive data between communication terminals is also under development.

### DISCLOSURE OF INVENTION

### Technical Solutions

According to an embodiment, there is provided a data sharing method including: creating a topology indicating a configuration of a wireless network between a host terminal and a plurality of adjacent terminals located within a standard distance from the host terminal; transmitting the topology to the plurality of adjacent terminals; receiving a participation request message for requesting a participation in the wireless network according to the topology from at least one of the plurality of adjacent terminals; and sharing data, based on the topology, with at least one of the adjacent terminals having transmitted the participation request message.

The creating of the topology may include creating the topology that includes information about at least one of a connection structure between a plurality of terminals in the wireless network and an access right to data according to the connection structure.

The sharing of the data may include: receiving a data transmission signal from a user of the host terminal; and transmitting the data to an adjacent terminal connected to the host terminal based on the connection structure.

The creating of the topology may include receiving information about a connection structure between a plurality of terminals in the wireless network from a user of the host terminal, and creating the topology based on the received information.

The creating of the topology may include: extracting a plurality of pre-created topologies from a memory of the host terminal; displaying the plurality of topologies on a display device of the host terminal; receiving a selection signal on one of the plurality of topologies from a user of the host terminal; and creating a topology corresponding to the selection signal as the topology indicating the configuration of the wireless network.

The transmitting of the topology may include transmitting the topology to the plurality of adjacent terminals using a near field wireless communication method, and the sharing of the data may include sharing the data using the near field wireless communication method.

The creating of the topology may include: collecting information of at least one of locations and identifiers of the plurality of adjacent terminals; and creating the topology based on the collected information.

According to another embodiment, there is provided a data sharing apparatus including: a topology creator configured to create a topology indicating a configuration of a wireless network between a plurality of adjacent terminals located within a standard distance from a current location; a topology transmitter configured to transmit the topology to the plurality of adjacent terminals; a message receiver configured to receive a participation request message for requesting a participation in the wireless network according to the topology from at least one of the plurality of adjacent terminals; and a data sharer configured to share data, based on the topology, with at least one of the adjacent terminals having transmitted the participation request message.

The topology creator may be configured to create the topology that includes information about at least one of a connection structure between a plurality of terminals in the wireless network and an access right to data according to the connection structure.

The data sharer may be configured to receive a data transmission signal from a user of the host terminal, and to transmit the data to an adjacent terminal connected to the host terminal based on the connection structure.

The topology creator may be configured to receive information about a connection structure between a plurality of terminals in the wireless network from a user of the host terminal, and to create the topology based on the received information.

The topology creator may be configured to extract a plurality of pre-created topologies from a memory of the host terminal, to display the plurality of topologies on a display device of the host terminal, to receive a selection signal on one of the plurality of topologies from a user of the host terminal, and to create a topology corresponding to the selection signal as the topology indicating the configuration of the wireless network.

The topology transmitter may be configured to transmit the topology to the plurality of adjacent terminals using a near field wireless communication method, and the data sharer may be configured to share the data using the near field wireless communication method.

The topology creator may be configured to collect information of at least one of locations and identifiers of the plurality of adjacent terminals, and to create the topology based on the collected information.

### Effects of the Invention

According to embodiments, it is possible to set and use a topology connection structure using a communication terminal of each user.

Also, according to embodiments, when a host terminal sets a new topology connection structure and posts the set new topology connection structure at a predetermined address, an adjacent terminal that is to participate in the new topology connection structure may perform an active participation.

Also, according to embodiments, it is possible to share locations or an arrangement state between adjacent terminals connected to a topology.

### BRIEF DESCRIPTION OF DRAWINGS

FIG. 1 is a flowchart illustrating a data sharing method according to an embodiment.

FIGS. 2 and 3 are diagrams describing a topology according to an embodiment.

FIG. 4 is a flowchart illustrating a method of creating a topology in a data sharing method according to an embodiment.

FIGS. 5 and 6 are diagrams describing an example of transmitting data using a topology according to an embodiment.

FIG. 7 is a block diagram illustrating a data sharing apparatus according to an embodiment.

### BEST MODE FOR CARRYING OUT THE INVENTION

Hereinafter, embodiments will be described with reference to the accompanying drawings.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification.

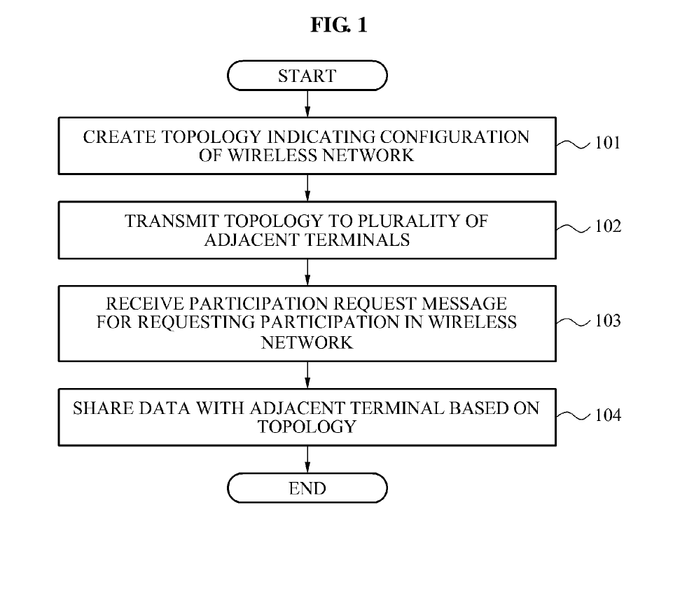

FIG. 1 is a flowchart illustrating a data sharing method according to an embodiment.

In operation 101, the data sharing method may create a topology indicating a configuration of a wireless network between a host terminal and a plurality of adjacent terminals located within a standard distance from the host terminal.

The topology refers to information about nodes constituting a network and a connection state between the nodes, and may be interpreted using a network structure or a line configuration method.

According to an embodiment, the topology created by the data sharing method may include information about at least one of a connection structure between a plurality of terminals in the wireless network and an access right to data according to the connection structure.

That is, in the present invention, a host terminal or an adjacent terminal may be included as a node.

Thus, the topology according to an embodiment may be expressed in one of a ring structure, a mesh structure, a star structure, a line structure, a tree structure, a bus structure, and a general graph structure.

The standard distance according to an embodiment may be interpreted as a set distance. For example, the standard distance may be interpreted as a distance set to be “1 meter” by a user.

As another example, the standard distance may be interpreted as a distance in which communication efficiency is greater than or equal to a threshold, for example, 80% within a distance supported by near field communication, such as Bluetooth and ZigBee.

According to an embodiment, the data sharing method may receive information about a connection structure between a plurality of terminals in the wireless network from a user of the host terminal, and may create the topology based on the received information.

That is, in the data sharing method according to an embodiment, the user may directly input topology information and may create the topology.

Here, an operation of receiving information about the connection structure between the plurality of terminals in the wireless network from the user of the host terminal and creating the topology based on the received information may be performed in real time.

For example, the user may load a topology creation tool for creating a topology using an interface of the host terminal. Accordingly, the user may directly create the topology by inputting topology information for controlling an addition, a creation, and a change of each of objects constituting the topology using the topology creation tool.

As another example, the data sharing method may extract a plurality of pre-created topologies from a memory of the host terminal, may receive a selection signal on one of the plurality of topologies, and may create a topology corresponding to the selection signal.

To this end, the host terminal may store various sample topologies that are classified into a ring structure, a mesh structure, a star structure, a line structure, a tree structure, a bus structure, and a general graph structure.

To create the topology, the data sharing method may collect information of at least one of locations and identifiers of the plurality of adjacent terminals and may create the topology based on the collected information.

That is, the data sharing method may create the topology by collecting information associated with a topology creation from the adjacent terminals.

In operation 102, the data sharing method may transmit the topology to the plurality of adjacent terminals.

According to an embodiment, the data sharing method may control the host terminal to register the topology to a server connected to a network, and may control the plurality of adjacent terminals to connect to the server and to download the topology.

The data sharing method may control the host terminal to transmit the topology to adjacent terminals located in a near distance through near field distance wireless communication.

Accordingly, the data sharing method enables the topology to be shared between terminals even in a communication shadowing area.

In operation 103, the data sharing method may receive a participation request message for requesting a participation in the wireless network according to the topology from at least one of the plurality of adjacent terminals.

In operation 104, the data sharing method may share data, based on the topology, with at least one of the adjacent terminals having transmitted the participation request message.

According to an embodiment, to share, a data transmission signal may be received from the user of the host terminal and the data may be transmitted to an adjacent terminal connected to the host terminal based on the connection structure.

In the data sharing method according to an embodiment, the plurality of adjacent terminals may actively participate in the wireless network through the topology.

In addition, in the data sharing method, the plurality of adjacent terminals may request the host terminal for changing the topology.

For example, an adjacent terminal may transmit, to the host terminal, information about another topology connected to the adjacent terminal over a network.

Accordingly, the host terminal may add information about the other topology received from the adjacent terminal, and may retransmit an updated topology to the adjacent terminals.

Accordingly, a mobile terminal may actively participate in a connection structure using a topology, and may actively construct the network using the topology by sharing locations or an arrangement state between mobile terminals connected to the topology.

The host terminal may display a topology expressed in a graph for a user, and may transmit data to an adjacent terminal in response to a signal input to the topology from the user.

For example, the user may drag a selected file from a source node to a destination node using a topology, thereby transmitting the selected file from a terminal of the source node to a terminal of the destination node.

That is, according to an embodiment, the data sharing method may transmit the generated topology to adjacent terminals by selecting locations of adjacent terminals on the topology using a variety of motions.

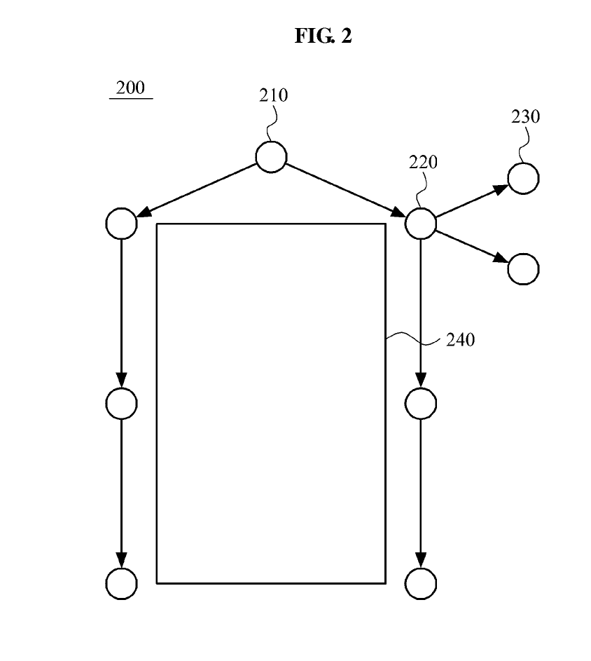

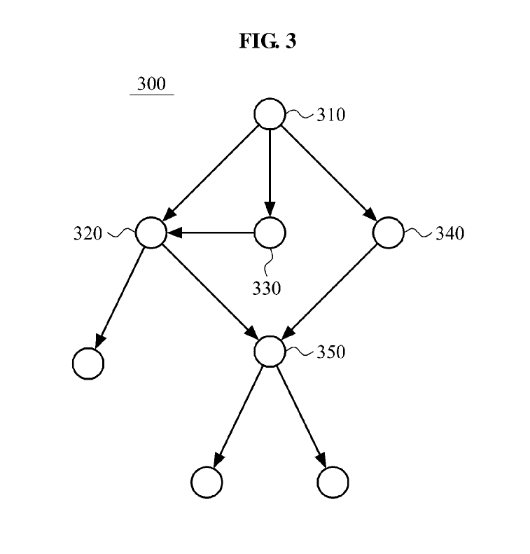

FIGS. 2 and 3 are diagrams describing a topology according to an embodiment.

In more detail, a data sharing method using a topology 200 according to an embodiment will be described with reference to FIG. 2.

A host terminal 210 may create the topology 200 by considering adjacent terminals.

The topology 200 according to an embodiment may be configured using a host terminal 210 classifiable as a parent node and adjacent terminals classifiable as child nodes. According to an embodiment, the host terminal 210 may have a right to access the adjacent terminals and each of the adjacent terminals may have a right to access a child node of each adjacent terminal. In this case, the host terminal 210 may access an adjacent terminal 220, however, the adjacent terminal 220 may not access the host terminal 210. Similarly, the adjacent terminal 220 may access an adjacent terminal 230 corresponding to a child node of the adjacent terminal 220, and the adjacent terminal 230 may not access the adjacent terminal 220.

In the present specification, a direction of an indicator with an arrow bow connected between nodes may be interpreted as such a right. That is, an access right may be interpreted to be present in the direction of the indicator with the arrow bow between the nodes.

According to another embodiment, adjacent terminals may have a right to access each other through different user settings on the access right between terminals. For example, the adjacent terminal 220 may access the adjacent terminal 230 and the adjacent terminal 230 may also access the adjacent terminal 220.

That is, in the data sharing method according to an embodiment, a user may set an access right between terminals and terminals participating in a topology may access an adjacent terminal based on the set access right.

The topology 200 may be applicable to a network in a generally small scale, such as a meeting in which a table 240 is located on the center and adjacent terminals 220 are present around the table 240.

The host terminal 210 may transmit the created topology 200 to adjacent terminals located within a meeting room and may use the topology 200 to share data occurring during a progress of the meeting.

Here, a user of the adjacent terminal 220 may also grant persons such as a secretary a right to share a portion of the data.

That is, the adjacent terminal 220 may transmit, to the hot terminal 210, the topology created based on a relationship with the secretary.

Accordingly, the host terminal 210 may apply the topology received from the adjacent terminal 220 to a pre-created topology.

A data sharing method using a topology 300 according to an embodiment will be described with reference to FIG. 3.

A host terminal 310 may also create the topology 300 according to an embodiment.

The topology 300 may also be referred to as a hierarchical type as a form in which a plurality of terminals 320, 330, 340, and 350 is connected to the host terminal 310 in a form similar to a tree type.

In this structure, the host terminal 310 may transmit data to all the adjacent terminals connected on the topology.

The present invention may use a tree-structure topology, and may also use a topology in a structure of FIG. 3, depending on embodiments. However, the present invention is not limited thereto.

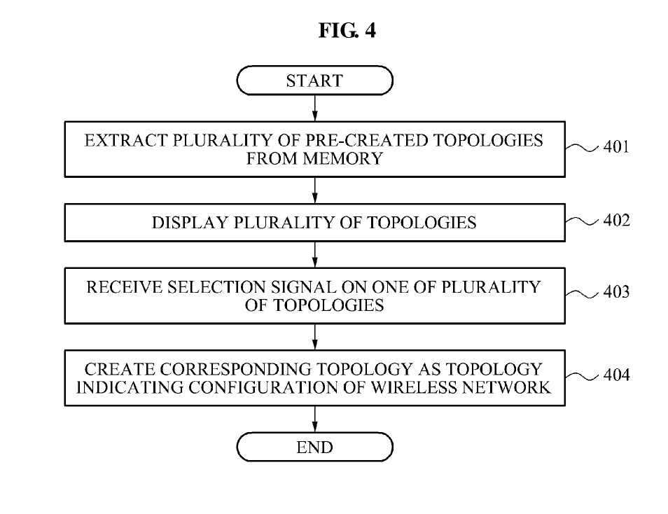

FIG. 4 is a flowchart illustrating a method of creating a topology in a data sharing method according to an embodiment.

In operation 401, the data sharing method may extract a plurality of pre-created topologies from a memory of the host terminal.

For example, the data sharing method may extract, from the memory of the host terminal, a topology expressed in one of a ring structure, a mesh structure, a star structure, a line structure, a tree structure, a bus structure, and a general graph structure.

The data sharing method may display the plurality of topologies on a display device of the host terminal in operation 402, and may receive a selection signal on one of the plurality of topologies from a user of the host terminal in operation 403.

In operation 404, the data sharing method may create a topology corresponding to the selection signal as the topology indicating the configuration of the wireless network.

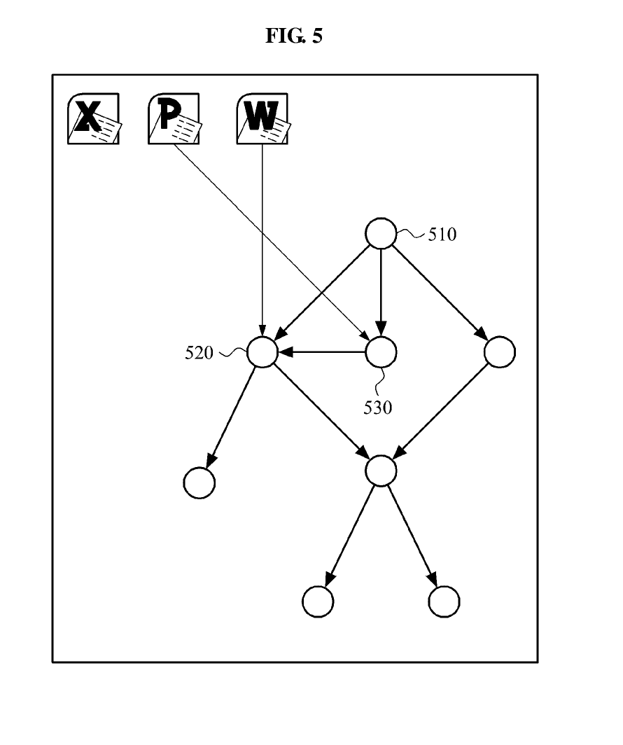

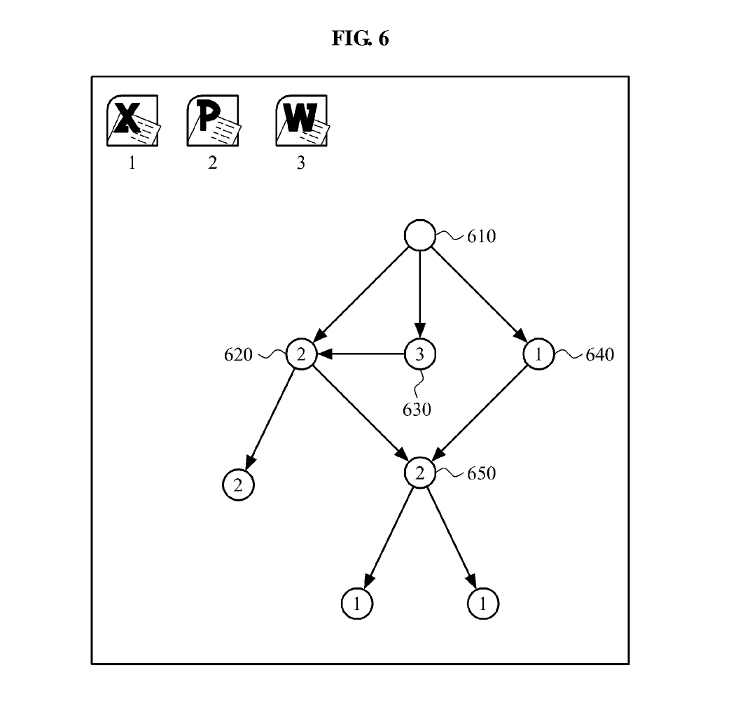

FIGS. 5 and 6 are diagrams describing an example of transmitting data using a topology according to an embodiment.

Initially, an embodiment in which a user transmits data from a host terminal to an adjacent terminal will be described with reference to FIG. 5.

The user may verify a topology displayed on a display of a host terminal 510, and may select nodes on the topology corresponding to adjacent terminals to which data is to be transmitted from the host terminal 510.

For example, the user may touch a file to be transmitted, may drag the touched file to be on nodes 520 and 530 on the topology, and may control data to be transmitted from the host terminal 510 to the adjacent terminals identified as the nodes 520 and 530.

As another example, the user may touch a file to be transmitted, may continuously touch the host terminal 510 corresponding to a source node to transmit the file and the nodes 520 and 530 corresponding to destination nodes on the topology, and may control data to be transmitted from the host terminal 510 identified as the source node to the adjacent terminals 520 and 530 identified as the destination nodes.

An embodiment of assigning a right level about adjacent terminals on a topology and allowing the adjacent terminals to have a different access right to files will be described with reference to FIG. 6.

A user may assign a right level to each node on the topology.

That is, a right level may be assigned to nodes connected to a tree structure starting from a host terminal 610.

In detail, the user may assign “2” as a right level of a node 620, may assign “3” as a right level of a node 630, may assign “1” as a right level of a node 640, and may assign “2” as a right level of a node 650.

An access right may be interpreted to increase in order of the right levels “1”, “2”, and “3”.

Accordingly, when the host terminal 610 broadcasts files classified into the right levels “1”, “2”, and “3” to the topology, only an adjacent terminal of a node having a corresponding right level may receive a corresponding file.

For example, only nodes 620, 630, and 650 may receive files classified into the right levels “2” and “3”. The node 640 has the right level “1” and thus, may not receive files classified into higher right levels “2” and “3”.

Such a right level may be set and changed by the user through the host terminal 610. In addition, even the adjacent terminal the user has granted a right may also set and change the right level.

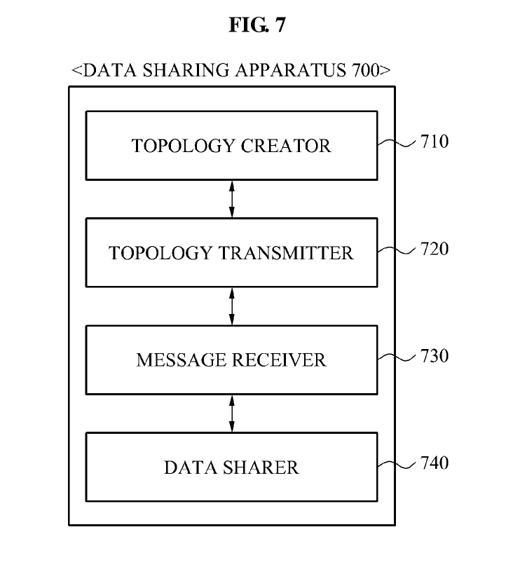

FIG. 7 is a block diagram illustrating a data sharing apparatus 700 according to an embodiment.

The data sharing apparatus 700 according to an embodiment may include a topology creator 710, a topology transmitter 720, a message receiver 730, and a data sharer 740.

The topology creator 710 may create a topology indicating a configuration of a wireless network between a plurality of adjacent terminals located within a standard distance from a current location.

The topology creator 710 may create the topology.

Here, the created topology may include information about at least one of a connection structure between a plurality of terminals in the wireless network and an access right to data according to the connection structure.

The topology creator 710 may receive information about a connection structure between a plurality of terminals in the wireless network from a user of the host terminal, and may create the topology based on the received information.

That is, using the topology creator 710, the user may create the topology by directly inputting topology information.

The topology creator 710 may collect information of at least one of locations and identifiers of the plurality of adjacent terminals, and may create the topology based on the collected information.

The topology creator 710 may verify in advance current locations of adjacent terminals and identifiers of the adjacent terminals.

The topology creator 710 may extract a plurality of pre-created topologies from a memory of the host terminal, may display the plurality of topologies on a display device of the host terminal, may receive a selection signal on one of the plurality of topologies from the user of the host terminal, and may create a topology corresponding to the selection signal as the topology indicating the configuration of the wireless network.

The topology transmitter 720 may transmit the topology to the plurality of adjacent terminals.

As an example, the topology transmitter 720 may transmit the topology to the plurality of adjacent terminals through a server.

As another example, the topology transmitter 720 may directly transmit the topology to the plurality of adjacent terminals through near field communication.

The message receiver 730 may receive a participation request message for requesting a participation in the wireless network according to the topology from at least one of the plurality of adjacent terminals.

According to the present invention, the adjacent terminals may include an adjacent terminal that is not to participate in the wireless network that the host terminal is to form using the topology.

To this end, the message receiver 730 may receive a participation request message required to verify an adjacent terminal that desires to participate in the wireless network according to the topology, from at least one of the plurality of adjacent terminals.

The data sharer 740 may share data, based on the topology, with at least one of the adjacent terminals having transmitted the participation request message.

As an example, the data sharer 740 may share the data with the plurality of adjacent terminals through the server, or may directly transmit the data to the plurality of adjacent terminals through near field communication and thereby share the data.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of sharing data by a host terminal, the method comprising:
creating a topology indicating a configuration of a wireless network between the host terminal and a plurality of adjacent terminals located within a standard distance from the host terminal;
transmitting the topology to the plurality of adjacent terminals;
receiving a participation request message for requesting a participation in the wireless network according to the topology from at least one of the plurality of adjacent terminals; and
sharing data, based on the topology, with at least one of the adjacent terminals having transmitted the participation request message.

2. The method of claim 1, wherein the creating of the topology comprises creating the topology that comprises information about at least one of a connection structure between a plurality of terminals in the wireless network and an access right to data according to the connection structure.

3. The method of claim 2, wherein the sharing of the data comprises:
receiving a data transmission signal from a user of the host terminal; and
transmitting the data to an adjacent terminal connected to the host terminal based on the connection structure.

4. The method of claim 1, wherein the creating of the topology comprises receiving information about a connection structure between a plurality of terminals in the wireless network from a user of the host terminal, and creating the topology based on the received information.

5. The method of claim 1, wherein the creating of the topology comprises:
extracting a plurality of pre-created topologies from a memory of the host terminal;
displaying the plurality of topologies on a display device of the host terminal;
receiving a selection signal on one of the plurality of topologies from a user of the host terminal; and
creating a topology corresponding to the selection signal as the topology indicating the configuration of the wireless network.

6. The method of claim 1, wherein the transmitting of the topology comprises transmitting the topology to the plurality of adjacent terminals using a near field wireless communication method, and
the sharing of the data comprises sharing the data using the near field wireless communication method.

7. The method of claim 1, wherein the creating of the topology comprises:
collecting information of at least one of locations and identifiers of the plurality of adjacent terminals; and
creating the topology based on the collected information.

8. A non-transitory computer-readable media recording a program to implement the method according to claim 1.

9. A data sharing apparatus comprising:
a topology creator configured to create a topology indicating a configuration of a wireless network between a plurality of adjacent terminals located within a standard distance from a current location;
a topology transmitter configured to transmit the topology to the plurality of adjacent terminals;
a message receiver configured to receive a participation request message for requesting a participation in the wireless network according to the topology from at least one of the plurality of adjacent terminals; and
a data sharer configured to share data, based on the topology, with at least one of the adjacent terminals having transmitted the participation request message.

10. The data sharing apparatus of claim 9, wherein the topology creator is configured to create the topology that comprises information about at least one of a connection structure between a plurality of terminals in the wireless network and an access right to data according to the connection structure.

11. The data sharing apparatus of claim 10, wherein the data sharer is configured to receive a data transmission signal from a user of the host terminal, and to transmit the data to an adjacent terminal connected to the host terminal based on the connection structure.

12. The data sharing apparatus of claim 9, wherein the topology creator is configured to receive information about a connection structure between a plurality of terminals in the wireless network from a user of the host terminal, and to create the topology based on the received information.

13. The data sharing apparatus of claim 9, wherein the topology creator is configured to extract a plurality of pre-created topologies from a memory of the host terminal, to display the plurality of topologies on a display device of the host terminal, to receive a selection signal on one of the plurality of topologies from a user of the host terminal, and to create a topology corresponding to the selection signal as the topology indicating the configuration of the wireless network.

14. The data sharing apparatus of claim 9, wherein the topology transmitter is configured to transmit the topology to the plurality of adjacent terminals using a near field wireless communication method, and
the data sharer is configured to share the data using the near field wireless communication method.

15. The data sharing apparatus of claim 9, wherein the topology creator is configured to collect information of at least one of locations and identifiers of the plurality of adjacent terminals, and to create the topology based on the collected information.
